(19) United States
(12) Patent Application Publication
(10) Pub. No.: US 2007/0089623 A1
(43) Pub. Date: Apr. 26, 2007

(54) Water-Based-Varnish Drying Apparatus and Printing Press

(75) Inventors: Kazuhiko Hamamoto, Tokyo (JP); Shinya Kobayashi, Tokyo (JP); Kazutada Dejima, Tokyo (JP)

Correspondence Address: LOWE HAUPTMAN BERNER, LLP, 1700 DIAGONAL ROAD, SUITE 300, ALEXANDRIA, VA, 22314, US

(73) Assignee: Mitsubishi Heavy Industries, Ltd., Tokyo (JP)

(21) Appl. No.: 11/550,145

(22) Filed: Oct. 17, 2006

(30) Foreign Application Priority Data
Oct. 18, 2005 (JP) 2005-302648

(51) Int. Cl. B41F 35/00

(52) U.S. Cl. 101/424.1

(57) ABSTRACT

A heating unit heats a sheet. A first measuring unit measures or estimates a first temperature of surface of the sheet before the sheet is conveyed to the heating unit. A heating control unit controls an output of the heating unit, in such a manner that the first temperature output from the first measuring unit becomes equal to or higher than a first predetermined temperature that is necessary for drying a water-based varnish coated on a surface of an ink that is transferred onto one side of the sheet.

### BACKGROUND OF THE INVENTION

1. Field of the Invention

The present invention relates to a water-based-varnish drying apparatus for a printing press that applies a water-based-varnish on an ink transferred onto paper to coat the paper and, then, dries this varnish coating surface and a printing press including the water-based-varnish drying apparatus, and, more particularly to a water-based-varnish drying apparatus for a duplex printing press that applies printing to both sides of paper without reversing the paper and a printing press including the water-based-varnish drying apparatus.

2. Description of the Related Art

In a sheet-fed perfecting offset press, a back-side printing unit and a front-side printing unit are coupled by a translink unit. In each of the printing units, printing units, coating units, and drying devices for a plurality of ink colors (e.g., cyan, magenta, yellow, black, and a special color as required) are provided along a conveyance path of a print sheet. When the print sheet is fed to the back-side printing unit from a feeder unit, ink are transferred onto the rear side of the print sheet from printing cylinders in the respective printing units, a water-based-varnish is applied on the inks in the coating units, and a hot air is supplied to dry a varnish coating surface in the drying devices. The print sheet having printing applied on the rear side is conveyed from the translink unit to the front-side printing unit. The inks are transferred from the printing cylinders to the front side of the print sheet in the respective printing units, the water-based-varnish is applied on the inks in the coating units, and the hot air is supplied to dry a varnish coating surface in the drying device. Then, the print sheet is discharged to a delivery unit.

In the duplex offset sheet printing press constituted as described above, in the back-side printing unit, to prevent the rear side of the print sheet (a printed surface) from being scratched when printing is performed in the front-side printing unit, it is necessary to surely dry the water-based-varnish, which coats the printed surface, with a drying device before the print sheet is passed to the front-side printing unit. In the front-side printing unit, to prevent the front side of the print sheet from being scratched when the print sheet is stacked in the delivery unit, it is necessary to surely dry the water-based-varnish with the drying device.

As the drying device for the conventional duplex offset sheet printing press, there is one described in Japanese Patent Application Laid-open No. 2005-22398. A duplex sheet printing press described in this laid-open patent application applies printing to both sides of a print sheet without reversing the print sheet. The duplex sheet printing press applies printing to the rear side of the print sheet in a back-side printing unit, applies an ultraviolet (UV) varnish on the rear side of the print sheet in a back-side coating unit and, then, conveys the print sheet to a front-side printing unit via a translink unit to apply printing to the front side of the print sheet in the front-side printing unit. In such a duplex printing press, if the UV varnish applied on the rear side is not completely dried, the UV varnish peels off at the time of front-side printing in the front-side printing unit. Thus, a UV-varnish drying device including a UV lamp is provided in the translink unit and the rear side of the print sheet is exposed to the UV lamp to completely dry the UV varnish.

In the duplex sheet printing press described in Japanese Patent Application Laid-open No. 2005-22398, the print sheet is coated with the UV varnish. However, when the print sheet is coated with a water-based-varnish, it is necessary to provide, instead of the UV-varnish drying device, an infrared (IR) device that irradiates an infrared ray to heat the print sheet using an IR lamp or a hot air device that heats the print sheet with a hot air.

However, when the IR device or the hot air device is used, it is extremely difficult to keep the temperature of the print sheet at an optimum temperature suitable for drying. When a sheet surface temperature falls below a predetermined temperature, it is likely that the water-based-varnish is insufficiently dried. When the water-based-varnish applied on the rear side is insufficiently dried, as in the case of incomplete drying of the UV varnish, the water-based-varnish peels off at the time of front side printing in the front-side printing unit, resulting in deterioration of a print quality. When the water-based-varnish applied on the front side is insufficiently dried, print sheets adhere to one another when the print sheets are stacked in the delivery unit, resulting in deterioration of a print quality.

On the other hand, at the time of drying of the print sheet, the print sheet heated by the IR device or the hot air device is thermally expanded. When printing is applied in the front-side printing unit in that state, pattern registration may be wrong. When the print sheet is discharged in a hot state, sheet alignment tends to be unstable if the print sheet is stacked in the delivery unit. Therefore, it is necessary to cool the print sheet to lower the temperature thereof to be equal to or lower than the predetermined temperature after being heated and dried by the IR device or the hot air device. It is also important for improvement of the print quality to set a sheet surface temperature at this point to an optimum temperature.

### SUMMARY OF THE INVENTION

It is an object of the present invention to at least partially solve the problems in the conventional technology.

An apparatus according to one aspect of the present invention is for drying a water-based varnish coated on a surface of an ink that is transferred onto one side of a sheet in a printing press. The apparatus includes a heating unit that heats the sheet; a first measuring unit that measures or estimates a first temperature of surface of the sheet before the sheet is conveyed to the heating unit; and a heating control unit that controls an output of the heating unit, in such a manner that the first temperature output from the first measuring unit becomes equal to or higher than a first predetermined temperature that is necessary for drying the varnish.

A printing press according to another aspect of the present invention includes a coating device that applies a water-based varnish on a surface of a sheet onto which an ink is transferred; and a drying device that dries the varnish coated on the surface of the sheet. The drying device includes a heating unit that heats the sheet; a measuring unit that measures or estimates a temperature of surface of the sheet before the sheet is conveyed to the heating unit; and a heating control unit that controls an output of the heating unit, in such a manner that the temperature output from the measuring unit becomes equal to or higher than a predetermined temperature that is necessary for drying the varnish.

An apparatus according to still another aspect of the present invention is for drying a water-based varnish coated on a surface of an ink that is transferred onto one side of a sheet in a printing press. The apparatus includes a heating unit that heats the sheet; a first measuring unit that measures or estimates a first temperature of surface of the sheet heated by the heating unit; and a heating control unit that controls an output of the heating unit, in such a manner that the first temperature output from the first measuring unit becomes equal to or higher than a first predetermined temperature that is necessary for drying the varnish.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram of a water-based-varnish drying apparatus for a printing press according to a first embodiment of the present invention;

FIG. 2 is a schematic diagram of a control block in the water-based-varnish drying apparatus for a printing press according to the first embodiment;

FIG. 3 is a schematic diagram of output reduction control for an infrared-ray irradiating device in the water-based-varnish drying apparatus for a printing press according to the first embodiment;

FIG. 4 is a schematic diagram of output increase control for the infrared-ray irradiating device in the water-based-varnish drying apparatus for a printing press according to the first embodiment;

FIG. 5 is a schematic diagram of output control for a cooling device in the water-based-varnish drying apparatus for a printing press according to the first embodiment;

FIG. 6 is a schematic diagram of output control for an exhaust device in the water-based-varnish drying apparatus for a printing press according to the first embodiment;

FIG. 7 is a schematic diagram of a duplex offset sheet printing press to which the water-based-varnish drying apparatus for a printing press according to the first embodiment is applied;

FIG. 8 is a schematic diagram of a water-based-varnish drying apparatus for a printing press according to a second embodiment of the present invention;

FIG. 9 is a schematic diagram of a control block in the water-based-varnish drying apparatus for a printing press according to the second embodiment;

FIG. 10 is a schematic diagram of output control for an exhaust device in the water-based-varnish drying apparatus for a printing press according to the second embodiment; and

FIG. 11 is a schematic diagram of output control for a cooling device in the water-based-varnish drying apparatus for a printing press according to the second embodiment.

### DETAILED DESCRIPTION OF THE PREFERRED EMBODIMENTS

Exemplary embodiments of the present invention are explained in detail below with reference to the accompanying drawings. The present invention is not limited by the embodiments.

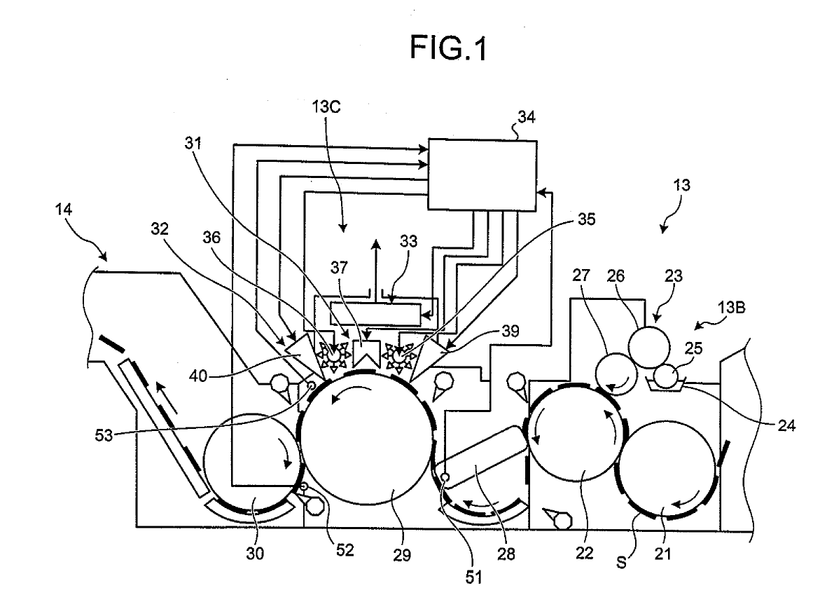

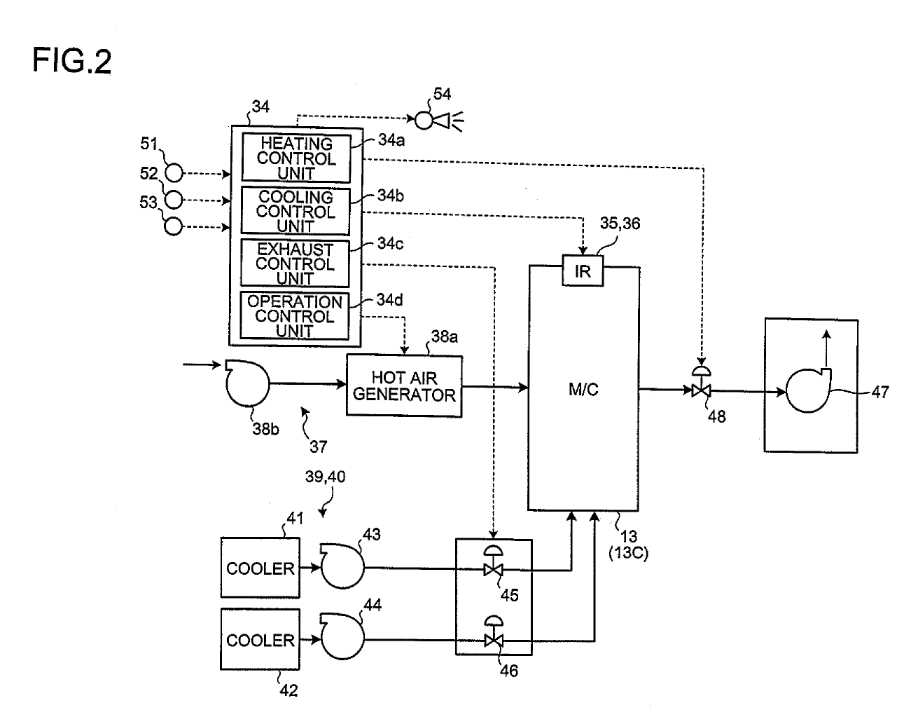

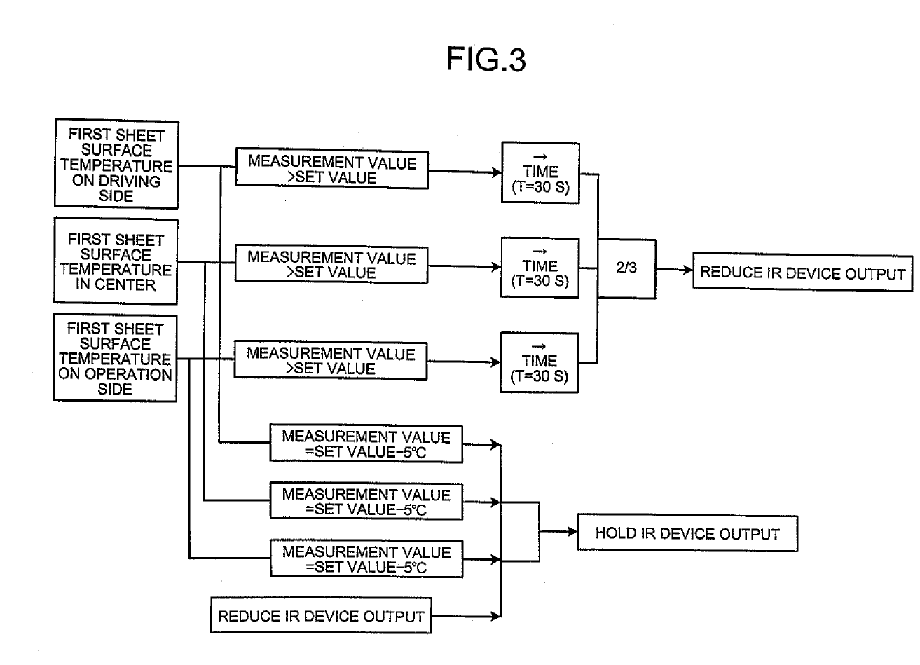

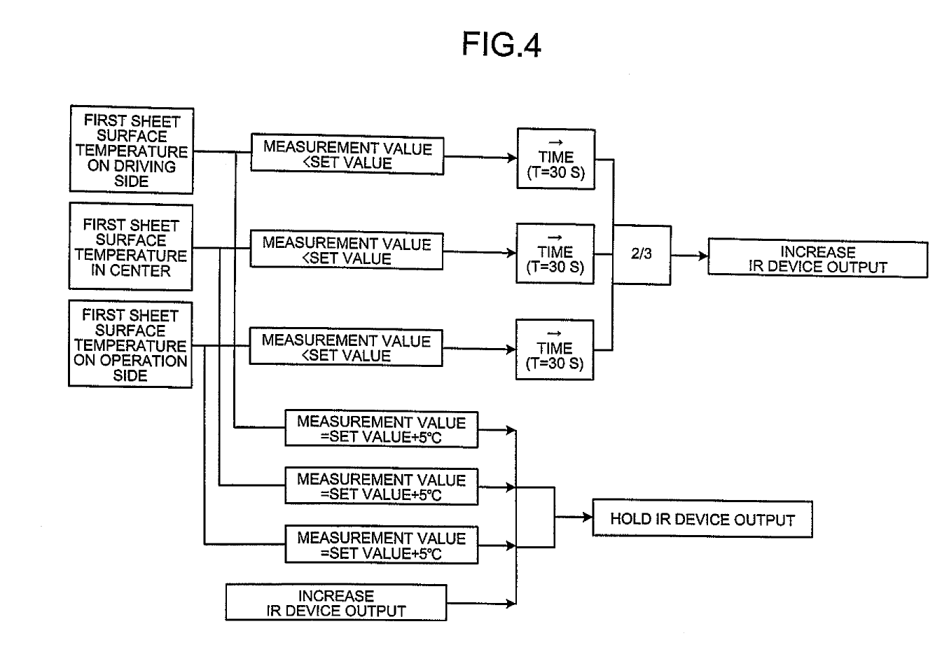

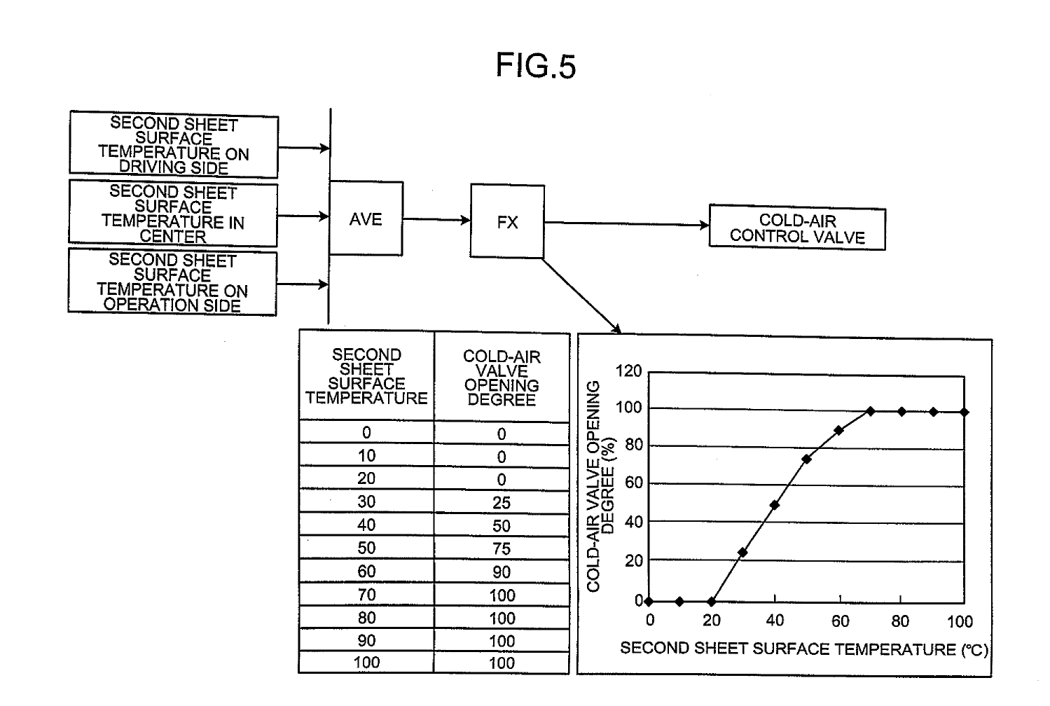

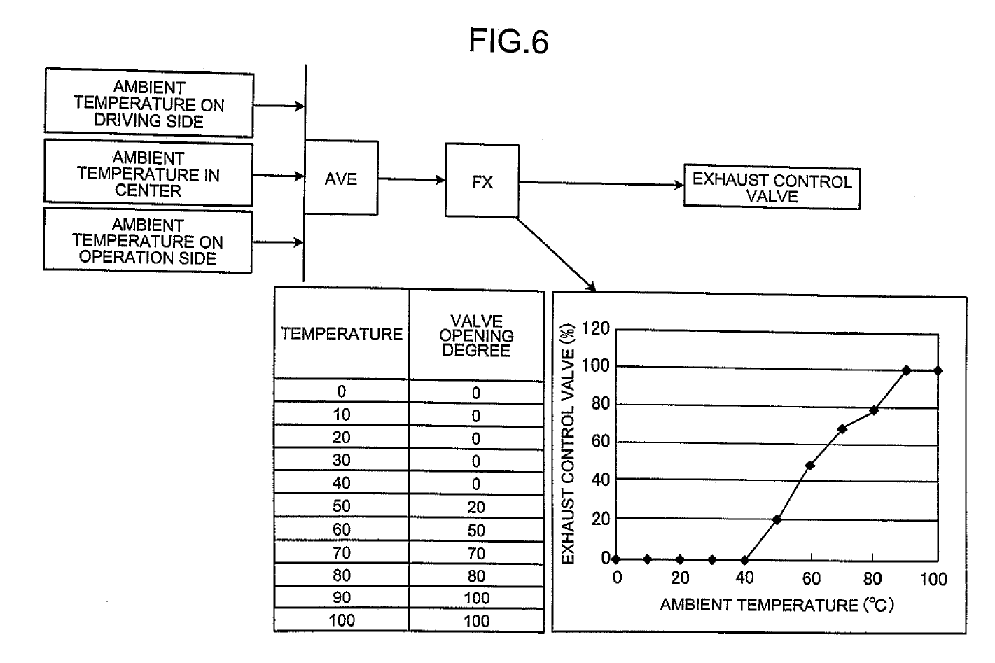

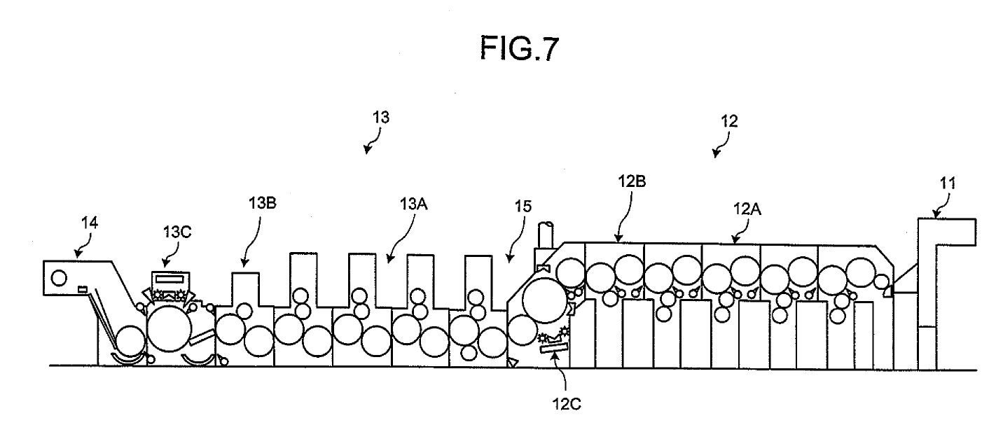

FIG. 1 is a schematic diagram of a water-based-varnish drying apparatus for a printing press according to a first embodiment of the present invention. FIG. 2 is a schematic diagram of a control block in the water-based-varnish drying apparatus for a printing press according to the first embodiment. FIG. 3 is a schematic diagram of output reduction control for an infrared-ray irradiating device in the water-based-varnish drying apparatus for a printing press according to the first embodiment. FIG. 4 is a schematic diagram of output increase control for the infrared-ray irradiating device in the water-based-varnish drying apparatus for a printing press according to the first embodiment. FIG. 5 is a schematic diagram of output control for a cooling device in the water-based-varnish drying apparatus for a printing press according to the first embodiment. FIG. 6 is a schematic diagram of output control for an exhaust device in the water-based-varnish drying apparatus for a printing press according to the first embodiment. FIG. 7 is a schematic diagram of a duplex offset sheet printing press to which the water-based-varnish drying apparatus for a printing press according to the first embodiment is applied;

The duplex offset sheet printing press to which the water-based-varnish drying apparatus for a printing press according to the first embodiment is applied includes, as shown in FIG. 7, a feeder unit 11, a back-side printing unit 12, a front-side printing unit 13, and a delivery unit 14. The back-side printing unit 12 and the front-side printing unit 13 are coupled by a translink unit 15. The back-side printing unit 12 and the front-side printing unit 13 include printing units 12A and 13A, coating units 12B and 13B, and drying devices 12C and 13C, respectively.

In the printing press having the structure described above, when a sheet S is fed from the feeder unit 11 to the back-side printing unit 12, first, in the printing unit 12A, inks of four colors (according to the present embodiment, cyan, magenta, yellow, and black) are transferred onto the rear side of the sheet S, which is a print surface, via printing cylinders, respectively. Thereafter, in the coating unit 12B, a water-based-varnish is applied on the inks. In the drying device 12C, a varnish coating surface is dried. The sheet S is conveyed to the front-side printing unit 13 through the translink unit 15. As in the print processing in the back-side printing unit 12, with the front side of the sheet S having printing applied to the rear side set as a print surface, in the printing unit 13A of the front-side printing unit 13, the inks of the four colors are transferred onto the front side of the sheet S in order via the printing cylinders. Thereafter, in the coating unit 13B, the water-based-varnish is applied on the inks. Subsequently, in the drying device 13C, a varnish coating surface is dried. The sheet S is discharged to the delivery unit 14. In this duplex offset sheet printing press, it is possible to apply printing to the front side of the sheet S without reversing the sheet S after printing is applied to the rear side of the sheet S.

In the duplex offset sheet printing press according to the present embodiment constituted as described above, in the drying device 13C in the front-side printing unit 13, it is necessary to keep a print surface temperature of a sheet at an optimum temperature suitable for drying. This is because, if the print surface temperature is low, the water-based-varnish is insufficiently dried and print sheets adhere to one another when the print sheets are stacked in the delivery unit 14 and the surfaces of the print sheets are scratched, resulting in deterioration of a print quality. According to the present embodiment, in the drying device 13C of the front-side printing unit 13, drying environment management is performed to surely dry the varnish coating surface at the optimum temperature to improve the print quality.

A structure of a printing unit is explained in detail below with reference to FIGS. 1 and 2. The coating unit 13B of the front-side printing unit 13 includes a transfer cylinder 21 to which the sheet S is passed from the printing unit 13A, a impression cylinder 22 that rotates in synchronization with conveyance of the sheet S while being opposed to the transfer cylinder 21 and in contact with the rear side of the sheet S, and a water-based-varnish applying device 23 that is provided to be opposed to the impression cylinder 22 across the sheet S and applies the water-based-varnish to the surface of the sheet S. The water-based-varnish applying device 23 includes a varnish pan 24 that stores the water-based-varnish, a varnish fountain roller 25 provided to be immersed in the varnish pan 24, a varnish form roller 26 provided in contact with the varnish fountain roller 25, and a varnish printing cylinder 27 provided in contact with the varnish form roller 26 and the surface of the sheet S supported by the peripheral surface of the impression cylinder 22 and conveyed.

Therefore, the sheet S having an ink transferred onto the surface thereof is conveyed from the transfer cylinder 21 to the impression cylinder 22. On the other hand, the water-based-varnish stored in the varnish pan 24 is supplied to the varnish printing cylinder 27 after properly kneaded by the varnish fountain roller 25 and the varnish form roller 26. The water-based-varnish is applied on the surface of the sheet S supported by the impression cylinder 22, that is, the ink transferred. Thereafter, the sheet S is passed to the drying device 13C.

The drying device 13C includes a conveyance mechanism 28 that conveys the sheet S passed from the coating unit 13B, a transfer cylinder (a triple diameter transfer cylinder) 29 that receives the sheet S from the conveyance mechanism 28, and a delivery cylinder 30 that discharges the sheet S after drying to the delivery unit 14. Further, the drying device 13C includes a heating device (a heating unit) 31 that heats the sheet S, a cooling device (a cooling unit) 32 that cools the sheet S heated by the heating device 31, and an exhaust device (an exhaust unit) that discharges a hot air in the drying device 13C to the outside of the printing press. The drying device 13C can be controlled to be driven by a control device (a heating control unit) 34.

The heating device 31 includes infrared (IR) irradiating devices 35 and 36 that irradiate infrared rays (IRs) and a hot-air blowing device 37 that blows a hot air. The IR irradiating devices 35 and 36 are provided above the transfer cylinder 29 along a conveyance direction of the sheet S. The IR irradiating devices 35 and 36 irradiate the IRs on the surface of the sheet S having the water-based-varnish coated thereon and heat the sheet S. The IR irradiating devices 35 and 36 can adjust outputs (heating temperatures) thereof by adjusting supplied power. Therefore, it is possible to heat, at a relatively early stage, the sheet S having the water-based-varnish applied thereon by the coating unit 13B by irradiating, using the IR irradiating devices 35 and 36, the IRs on the sheet S conveyed by the transfer cylinder 29.

The hot-air blowing device 37 is provided above the transfer cylinder 29 and between the two IR irradiating devices 35 and 36. The hot-air blowing device 37 blows a hot air on the surface of the sheet S supported by the peripheral surface of the transfer cylinder 29 and conveyed, and heats the sheet S. Specifically, the hot-air blowing device 37 includes a hot air generator 38a that generates a hot air and a suction fan 38b that sucks the atmosphere and sends the atmosphere to the hot air generator 38a. The hot-air blowing device 37 can adjust an output (a heating temperature) thereof by adjusting a hot air temperature of the hot air generator 38a.

The IR irradiating devices 35 and 36 and the hot-air blowing device 37 are provided on the surface side of the sheet S, which is a print surface to be dried. Thus, it is possible to efficiently heat a coating surface on the sheet S and completely dry the water-based-varnish applied on the surface of the sheet S. Since the IR irradiating devices 35 and 36 and the hot-air blowing device 37 are provided alternately in the sheet conveyance direction, it is possible to more efficiently heat the sheet S.

The cooling device 32 includes cold-air blowing devices 39 and 40 that blow cold airs to the sheet S. One cold-air blowing device 39 is provided above the transfer cylinder 29 and further on the upstream side in the sheet conveyance direction than the IR irradiating device 35. The other cold-air blowing device 40 is provided above the transfer cylinder 29 and further on the downstream side in the sheet conveyance direction than the IR irradiating device 36. Specifically, the cold-air blowing devices 39 and 40 include coolers 41 and 42 that generate cold airs, air blowing fans 43 and 44 that deliver the cold airs generated by the coolers 41 and 42, and cold-air regulation valves 45 and 46 that adjust flow rates of the cold airs delivered. It is possible to adjust outputs (cold air quantities) of the cold-air blowing devices 39 and 40 by adjusting opening degrees of the respective cold-air regulation valves 45 and 46.

The cold-air blowing devices 39 and 40 are provided on the surface side of the sheet S. Thus, it is possible to efficiently cool the sheet S and control unnecessary temperature rise of the sheet S due to the heating device 31.

An exhaust device 33 is provided above the IR irradiating devices 35 and 36 and the hot-air blowing device 37 constituting the heating device 31 and discharges the air (the hot air) in the drying device 13C to the outside of the printing press. Specifically, the exhaust device 33 includes an exhaust fan that discharges the hot air to the outside of the printing press and an exhaust-air regulation valve 48 that adjusts a quantity of the air discharged by an exhaust fan 47. It is possible to adjust an output (an exhaust air quantity) of the exhaust device 33 by adjusting an opening degree of the exhaust-air regulation valve 48.

According to the present embodiment, it is possible to control to drive the heating device 31, the cooling device 32, and the exhaust device 33 of the drying device 13C according to a sheet surface temperature of the sheet S conveyed and an ambient temperature. The drying device 13C includes a first temperature sensor (a first measuring unit or a print-surface-temperature measuring and estimating unit) 51 that measures a sheet surface temperature (a first temperature) of the sheet S before being conveyed to the heating device 31 and the cooling device 32, a second temperature sensor (a second measuring unit) 52 that measures a sheet surface temperature (a second temperature) of the sheet S after being conveyed from the cooling device 32, and a third temperature sensor (an ambient temperature measuring unit) 53 that measures an ambient temperature in the drying device 13C (an internal ambient temperature).

The first temperature sensor 51 is a non-contact temperature sensor. The first temperature sensor 51 is provided in a position further on the upstream side in the sheet conveyance direction than the heating device 31 and the cooling device 32 and on a front side in contact with the transfer cylinder 29. The first temperature sensor 51 always measures a sheet surface temperature of the sheet S supported by the peripheral surface of the transfer cylinder 29 and conveyed. The first temperature sensor 51 measures sheet surface temperatures in the center and at both ends in a width direction orthogonal to the conveyance direction of the sheet S.

The second temperature sensor 52 is a non-contact temperature sensor. The second temperature sensor 52 is provided in a position further on the downstream side in the sheet conveyance direction than the heating device 31 and the cooling device 32 and further on the downstream side in the sheet conveyance direction than the opposed contact unit of the transfer cylinder 29 and the delivery cylinder 30. The second temperature sensor 52 always measures a sheet surface temperature of the sheet S supported by the peripheral surface of the delivery cylinder 30 and conveyed. Like the first temperature sensor 51, the second temperature sensor 52 measures sheet surface temperatures in the center and at both the ends in the width direction orthogonal to the conveyance direction of the sheet S.

The third temperature sensor 53 is provided in a position above the transfer cylinder 29 and adjacent to the downstream side in the sheet conveyance direction of the cooling device 32. The third temperature sensor 53 always measures an ambient temperature in the drying device 13C. The third temperature sensor 53 does not have to be a non-contact temperature sensor. However, the ambient temperature in the drying device 13C tends to be affected by the transfer cylinder 29 in which a surface temperature rise is relatively large. Thus, it is preferable to measure a surface temperature of the transfer cylinder 29. In this case, it is advisable to use a non-contact temperature sensor as the third temperature sensor 53.

The control device 34 is, for example, a computer. The control device 34 includes a heating control unit 34a that controls an output of the heating device 31 based on the first temperature measured by the first temperature sensor 51, a cooling control unit 34b that controls an output of the cooling device 32 based on the second temperature measured by the second temperature sensor 52, an exhaust control unit 34c that controls an output of the exhaust device 33 based on the internal ambient temperature measured by the third temperature sensor 53, and an operation control unit (a safety control unit) 34d that controls operations of an alarm 54 and the printing press based on the internal ambient temperature measured by the third temperature sensor 53.

The first temperature measured by the first temperature sensor 51 is inputted to the heating control unit 34a. The heating control unit 34a controls outputs of the IR irradiating devices 35 and 36, or increases or decreases the outputs, to raise the first temperature of the sheet S before being conveyed to the heating device 31, which is obtained from the first temperature sensor 51, to a first predetermined temperature (e.g., temperature necessary for the water-based-varnish to dry, for example, 60°) set in advance. An output of the hot-air blowing device 37 may be increased or decreased according to the outputs of the IR irradiating devices 35 and 36. Therefore, since the sheet S before being conveyed to the heating device 31 is subjected to heat from the respective cylinders of the printing unit 12A or heat from the heating device of the drying device 12C when printing is applied by the back-side printing unit 12, it is likely that a sheet surface temperature of the sheet S fluctuates. It is possible to surely dry the water-based-varnish applied on the sheet S with the heating device 31 by increasing or decreasing the outputs of the IR irradiating devices 35 and 36 according to the first temperature of the sheet S before being conveyed to the heating device 31.

The second temperature measured by the second temperature sensor 52 is inputted to the cooling control unit 34b. The cooling control unit 34b controls outputs of the cold-air blowing devices 39 and 40, or increases or decreases the outputs, to lower the second temperature of the sheet S after being conveyed from the cooling device 32, which is obtained from the second temperature sensor 52, to be equal to or lower than a second predetermined temperature (temperature lower than the first predetermined temperature, for example, 20° C.) set in advance. Specifically, when the second temperature is equal to or lower than the second predetermined temperature, the cooling control unit 34b brings the cold-air regulation valves 45 and 46 of the cold-air blowing devices 39 and 40 into a closed state. When the second temperature exceeds the second predetermined temperature, the cooling control unit 34b brings the cold-air regulation valves 45 and 46 of the cold-air blowing devices 39 and 40 into an open state and adjusts opening degrees of the cold-air regulation valves 45 and 46 according to the second temperature. Therefore, since the sheet S discharged to the delivery unit 14 is subjected to heat when the sheet S is dried by the heating device 31, it is likely that a sheet surface temperature thereof fluctuates. It is possible to surely cool the sheet S discharged to the delivery unit 14 and control outputs of the cold-air blowing devices 39 and 40 to necessary minimum outputs by increasing or decreasing an output of the cooling device 32 according to the second temperature of the sheet S after being conveyed from the cooling device 32.

The internal ambient temperature measured by the third temperature sensor 53 is inputted to the exhaust control unit 34c. The exhaust control unit 34c controls an output of the exhaust device 33, or increases or decreases the output, to raise or lower the internal ambient temperature of the drying device 13C obtained from the third temperature sensor 53 to be equal to or lower than a third predetermined temperature (temperature lower than the first predetermined temperature and higher than the second predetermined temperature, for example, 40° C.). Specifically, when the internal ambient temperature is equal to or lower than the third predetermined temperature, the exhaust control unit 34c brings the exhaust-air regulation valve 48 into a closed state. When the internal ambient temperature exceeds the third predetermined temperature, the exhaust control unit 34c brings the exhaust-air regulation valve 48 into an open state. In addition, the exhaust control unit 34c adjusts an opening degree of the exhaust-air regulation valve 48 according to the internal ambient temperature. Therefore, it is likely that an ambient temperature rises in the drying device 13C because of the heating device 31 or the like to damage the printing press. It is possible to keep an appropriate internal temperature by increasing or decreasing an output of the exhaust device 33 according to the internal ambient temperature of the drying device 13C.

The internal ambient temperature measured by the third temperature sensor 53 is inputted to the operation control unit 34d. When the internal ambient temperature in the drying device 13C obtained from the third temperature sensor 53 rises to be equal to or higher than a fourth predetermined temperature (e.g., 80° C.) set in advance, the operation control unit 34d judges that the inside of the printing press is in an abnormal temperature state and actuates the alarm 54. When the internal ambient temperature rises to be equal to or higher than a fifth predetermined temperature (e.g., 100° C.), the operation control unit 34d stops operation of the printing press. Therefore, when the inside of the printing press is in the abnormal temperature state, it is likely that pawls of the printing cylinder or the conveyance cylinder, which grip the sheet S, loosen to drop the sheet S during conveyance. The abnormal temperature state damages the printing press. Thus, when the inside of the printing press is in the abnormal temperature state in this way, the operation control unit 34d actuates the alarm 54 or stops operation of the printing press.

In driving control by the heating device 31, as shown in FIG. 3, temperatures in three places in the width direction of the sheet S measured by the first temperature sensor 51, that is, a first temperature on the driving side, a first temperature in the center, and a first temperature on the operation side are always inputted to the heating control unit 34a. When the three first temperatures obtained from the first temperature sensor 51 are higher than the first predetermined temperature (60° C.) set in advance and this state continues for a predetermined time (e.g., 30 seconds), the heating control unit 34a reduces outputs of the IR irradiating devices 35 and 36. In this case, if at least two first temperatures of the three first temperatures continue to be higher than the first predetermined temperature for the predetermined time, the outputs of the IR irradiating devices 35 and 36 are reduced. However, three first temperatures or one first temperature may be used.

Thereafter, when the three first temperatures fall from the first predetermined temperature by a predetermined temperature (e.g., 5° C.) to be a first lower-limit temperature because of the reduction of the outputs of the IR irradiating devices 35 and 36, the heating control unit 34a keeps the outputs of the IR irradiating devices 35 and 36. In this case, when the three first temperatures fall to be the first lower-limit temperature, the heating control unit 34a keeps the outputs of the IR irradiating devices 35 and 36. However, one or two first temperatures may be used.

Therefore, when the first temperature of the sheet S before being conveyed to the heating device 31 is high, it is possible to properly perform drying of the water-based-varnish at the time of drying of the sheet S by the heating device 31 and secure a sufficient gloss of the surface of the sheet S by reducing the outputs of the IR irradiating devices 35 and 36. It is possible to surely prevent a surface temperature from rising again and maintain a surface temperature in drying the sheet S at stable temperature. Moreover, it is possible to control wasteful emission of energy in the IR irradiating devices 35 and 36 to realize a reduction of drying work cost. It is also possible to control damage to the printing press due to the heating device 31.

As shown in FIG. 4, when the three first temperature obtained from the first temperature sensor 51 are lower than the first predetermined temperature set in advance and this state continues for a predetermined time (e.g., 30 seconds), the heating control unit 34a increases the outputs of the IR irradiating devices 35 and 36. In this case, if at least two first temperatures of the three first temperatures continue to be lower than the first predetermined temperature for the predetermined time, the heating control unit 34a increases the outputs of the IR irradiating devices 35 and 36. However, one or three first temperatures may be used.

Thereafter, when the three first temperatures rise from the first predetermined temperature by a predetermined temperature (e.g., 5° C.) to be the first upper-limit temperature because of the increase of the outputs of the IR irradiating devices 35 and 36, the heating control unit 34a keeps the outputs of the IR irradiating devices 35 and 36. In this case, if the three first temperatures are the first upper-limit temperature, the heating control unit 34a keeps the outputs of the IR irradiating devices 35 and 36. However, one or two first temperatures may be used.

Therefore, when the first temperature of the sheet S before being conveyed to the heating device 31 is low, it is possible to surely perform drying of the sheet S by the heating device 31 and improve a print quality by increasing the outputs of the IR irradiating devices 35 and 36. It is also possible to surely prevent a sheet surface temperature from falling again and maintain a sheet surface temperature in drying the sheet S at stable temperature.

In the driving control by the cooling device 32, as shown in FIG. 5, temperatures in three places in the width direction of the sheet S measured by the second temperature sensor 52, that is, a second temperature on the driving side, a second temperature in the center, and a second temperature on the operation side are always inputted to the cooling control unit 34b. The cooling control unit 34b adjusts opening degrees of the cold-air regulation valves 45 and 46 to set an average of the three second temperatures obtained from the second temperature sensor 52 to be equal to or lower than the second predetermined temperature (20° C.) set in advance. According to the present embodiment, the cooling control unit 34b has a function map of cold-air regulation valve opening degrees with respect to the second sheet temperature and sets opening degrees of the cold-air regulation valves 45 and 46 based on the average of the three second temperatures measured.

Therefore, it is possible to surely cool the sheet S discharged to the delivery unit 14 and discharge the sheet S in a state of temperature equal to or lower than a proper temperature. It is also possible to control the outputs of the cold-air blowing devices 39 and 40 to necessary minimum outputs.

In the driving control by the exhaust device 33, as shown in FIG. 6, temperatures in three places in the width direction of the sheet S measured by the third temperature sensor 53, that is, an internal ambient temperature on the driving side, an internal ambient temperature in the center, and an internal ambient temperature on the operation side are always inputted to the exhaust control unit 34c. The exhaust control unit 34c adjusts a valve opening degree of the exhaust-air regulation valve 48 to set an average of the three internal ambient temperatures obtained from the third temperature sensor 53 to be equal to or lower than a third predetermined temperature (40° C.) set in advance. According to the present embodiment, the exhaust control unit 34c has a function map of exhaust-air regulation valve opening degrees with respect to the internal ambient temperature and sets an opening degree of the exhaust-air regulation valve 48 based on the average of the three internal ambient temperatures measured.

Therefore, by adjusting an opening degree of the exhaust-air regulation valve 48 according to an internal ambient temperature of the drying device 13C, it is possible to keep an appropriate internal temperature and minimize damage to the printing press caused by a rise in an ambient temperature due to the heating device 31 or the like.

Although not shown in the figure, when the average of the three internal ambient temperatures obtained from the third temperature sensor 53 is equal to or higher than a fourth predetermined temperature (e.g., 80° C.) set in advance, the operation control unit 34d actuates the alarm 54. When the average is equal to or higher than a fifth predetermined temperature (e.g., 100° C.), the operation control unit 34d stops operation of the printing press. Therefore, it is possible to control a failure in gripping of the sheet S by the pawls of the printing cylinder or the conveyance cylinder by actuating the alarm 54 or stopping operation of the printing press when an internal ambient temperature of the drying device 13C reaches an abnormal temperature. In addition, it is possible to minimize damage to the printing press caused by a rise of the ambient temperature due to the heating device 31 or the like.

As described above, in the printing press according to the first embodiment, the heating device 31 that heats the sheet S and the first temperature sensor 51 that measures the first temperature of the sheet S before being conveyed to the heating device 31 are provided. The heating control unit 34a controls outputs of the IR irradiating devices 35 and 36 in the heating device 31 to set the first temperature obtained from the first temperature sensor 51 to the first predetermined temperature necessary for drying of a varnish.

Therefore, by increasing or decreasing the outputs of the IR irradiating devices 35 and 36 based on the first temperature of the sheet S before being conveyed to the heating device 31, it is possible to control a sheet surface temperature in drying the sheet S to be an optimum temperature, surely dry the water-based-varnish applied on the surface of the sheet S, and control occurrence of scratches and fluctuation in a gloss of the surface of the sheet S after drying to improve a print quality.

In this case, the first temperature sensor 51 measures temperatures in three places in the width direction of the sheet S, that is, a first temperature on the driving side, a first temperature in the center, and a first temperature on the operation side. The heating control unit 34a controls outputs of the IR irradiating devices 35 and 36 using the three first temperatures. Therefore, even when there is fluctuation in a sheet surface temperature in the width direction at the time of conveyance of the sheet S, it is possible to properly control the heating device 31 to maintain a sheet surface temperature of the sheet S at the time of drying at an optimum temperature. An output of the heating device 31 only has to be increased or decreased when at least one first temperature deviates from the first predetermined temperature. An average of the three first temperatures may be used or an output of the heating device 31 may be increased or decreased stepwise according to a temperature change.

In the water-based-varnish drying apparatus for a printing press according to the present embodiment, the heating control unit 34a increases or decreases an output of the heating device 31 when the first temperature continues to deviate from the first predetermined temperature for the predetermined time set in advance. Therefore, it is possible to properly control the heating device 31 taking into account temporary fluctuation in the first temperature.

In the water-based-varnish drying apparatus for a printing press according to the present embodiment, after the first temperature rises to be higher than the first predetermined temperature and the heating control unit 34a reduces an output of the heating device 31, the heating control unit 34a maintains the output of the heating device 31 when the first sheet temperature falls to be lower than the first predetermined temperature to reach the first lower-limit temperature. After the first temperature falls to be lower than the first predetermined temperature and the heating control unit 34a increases an output of the heating device 31, the heating control unit 34a maintains the output of the heating device 31 when the first temperature falls to be lower than the first predetermined temperature to reach the first upper-limit temperature. Therefore, by maintaining an output of the heating device 31 after lowering or raising a sheet surface temperature of the sheet S to be lower or higher than the first predetermined temperature, it is possible to surely prevent the sheet surface temperature from rising or falling again to maintain a sheet surface temperature in drying the sheet S at stable temperature.

In the water-based-varnish drying apparatus for a printing press according to the present embodiment, the cooling device 32 that cools the sheet S located in a position further on the downstream side in the sheet conveyance direction than the heating device 31 and the second temperature sensor 52 that measures a second temperature of the sheet S after being conveyed from the cooling device 32 are provided. The cooling control unit 34b controls an output of the cooling device 32 to lower the second temperature obtained from the second temperature sensor 52 to be equal to or lower than the second predetermined temperature necessary for sheet discharge.

Therefore, by increasing or decreasing an output of the cooling device 32, or adjusting opening degrees of the cooling air valves 45 and 46, based on the second temperature of the sheet S after being conveyed from the cooling device 32, a sheet surface temperature after drying of the sheet S is controlled to an optimum temperature. It is possible to control occurrence of scratches on the surface of the sheet S at the time of sheet discharge to improve a print quality.

In the water-based-varnish drying apparatus for a printing press according to the present embodiment, the exhaust device 33 that discharges the air in the drying device 13C to the outside and the third temperature sensor 53 that measures an internal ambient temperature near the heating device 31 are provided. The exhaust control unit 34c controls an output of the exhaust device 33 to lower the internal ambient temperature obtained from the third temperature sensor 53 to be equal to or lower than the third predetermined temperature necessary for a normal operation of the printing press.

Therefore, by increasing or decreasing the output of the exhaust device 33 based on the internal ambient temperature near the heating device 31, an internal temperature in drying the sheet S is controlled to be an optimum temperature. It is possible to surely dry a varnish applied.

In the water-based-varnish drying apparatus for a printing press according to the present embodiment, when an internal ambient temperature rises to be equal to or higher than the fourth predetermined temperature at which abnormal driving of the printing press is anticipated, the alarm 54 is actuated or the printing press is stopped. Therefore, when the internal ambient temperature abnormally rises, it is possible to inform an operator of abnormality of the printing press by issuing an alarm, prevent a printing failure by stopping the printing press, and improve safety.

According to the present embodiment, the printing press is a duplex printing press in which, after ink transfer, varnish coating, and varnish drying are applied to the rear surface of a sheet, ink transfer, varnish coating, and varnish drying are applied to the front surface of the sheet. The water-based-varnish drying apparatus according to the present invention is applied to the drying device 13C that dries a varnish coating surface applied on the surface of the sheet. Therefore, even if a sheet surface temperature fluctuates because of varnish drying for the rear surface of the sheet S, by controlling an output of the heating device 31 based on a first temperature of the sheet S before being conveyed for surface printing, a sheet surfaced temperature in drying the sheet S is controlled to be an optimum temperature. It is possible to surely dry a varnish applied and control occurrence of scratches and fluctuation in a gloss of the surface of the sheet after drying to improve a print quality.

According to the present embodiment, the two IR irradiating devices 35 and 36 and the hot-air blowing device 37 are provided as the heating device 31. However, the numbers of IR irradiating devices and hot-air blowing devices are not limited to those according to the present embodiment and only have to be appropriately set according to a type of a printing press, a printing condition, and the like. The two cold-air blowing devices 39 and 40 are provided as the cooling device 32 and the one exhaust fan 47 is provided as the exhaust device 33. However, the numbers of cold-air blowing devices and exhaust fans only have to be appropriately set according to a type of a printing press, a printing condition, and the like.

In the explanation of the embodiment, the first temperature of the sheet S before being conveyed to the heating device 31 is 60° C., the second temperature of the sheet S after being conveyed from the cooling device 32 is 20° C., the internal ambient temperature of the drying device 13C is 40° C., the fourth predetermined temperature is 80° C., and the fifth predetermined temperature is 100° C. The first temperature, the second temperature, the internal ambient temperature, the fourth predetermined temperature, and the fifth predetermined temperature are not limited to these temperatures and, as described above, only have to be appropriately set according to a type of a printing press, a printing condition, and the like. The first and the second paper-surface-temperature measuring and estimating units and the ambient-temperature measuring and estimating unit according to the present invention are temperature sensors that directly measure temperature. However, in a position where it is difficult to attach a temperature sensor, it is also possible that temperature having a correlation with sheet surface temperatures and an ambient temperature is measured and the surface temperatures and the ambient temperature are estimated from this temperature. In this case, feedback control, feed-forward control, duty control, and the like may be used.

Moreover, in the explanation of the present embodiment, the water-based-varnish drying apparatus for a printing press according to the present invention is used for the drying device 13C of the front-side printing unit 13 in the duplex printing press that applies printing to both the sides of the sheet S without reversing the sheet S. However, it is also possible to use the water-based-varnish drying apparatus for the drying device 12C of the back-side printing unit 12. The water-based-varnish drying apparatus may be used for a duplex printing press that has a reversal cylinder for reversing the paper S and applies printing to both the sides of the sheet S by reversing the sheet S and a simplex printing press that applies printing to one side of the sheet S.

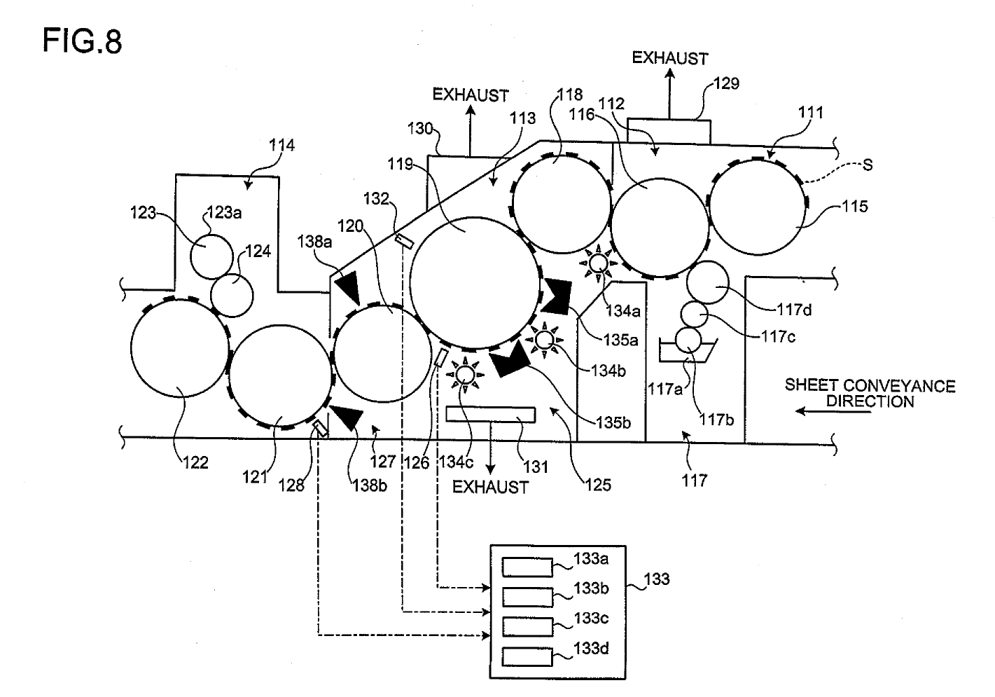

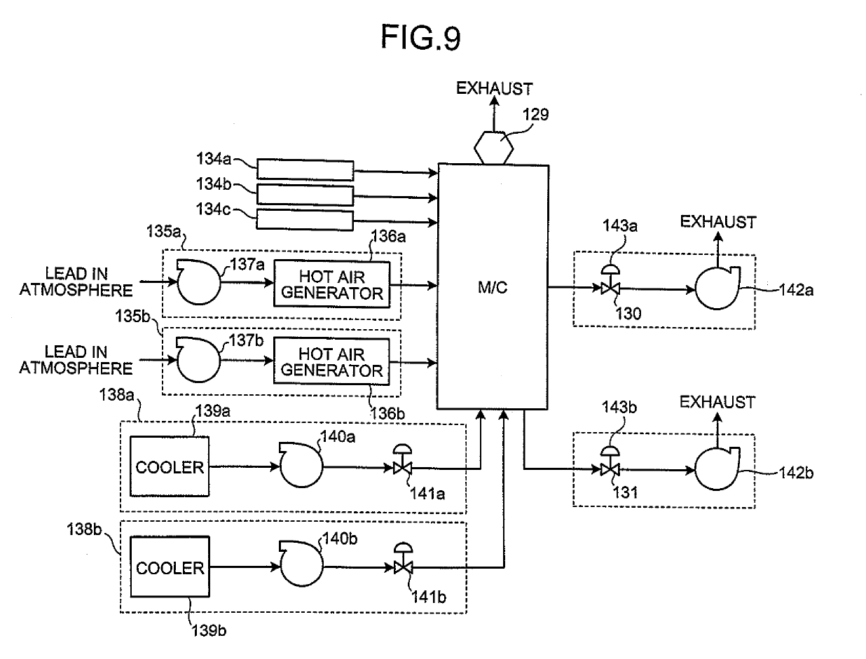

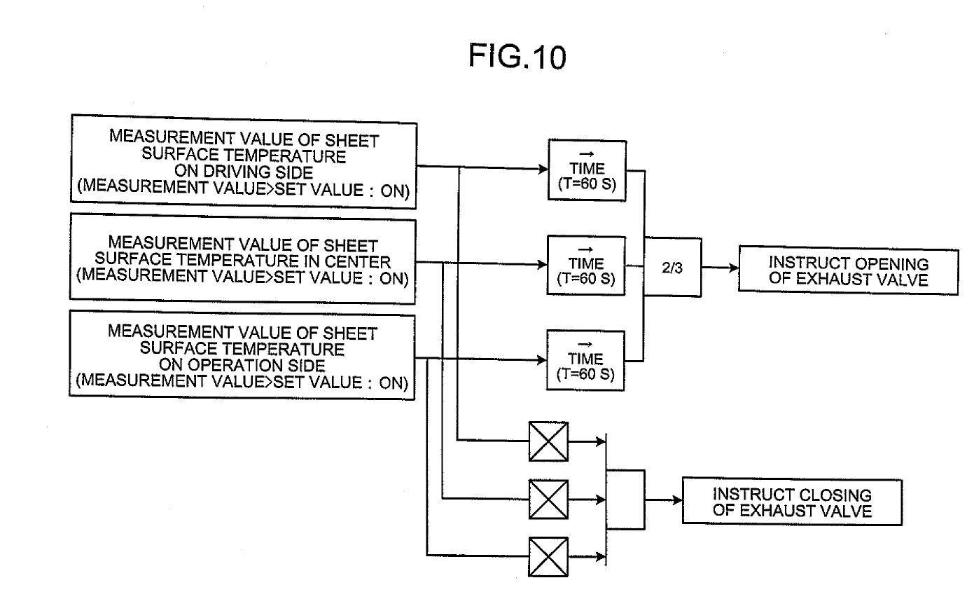

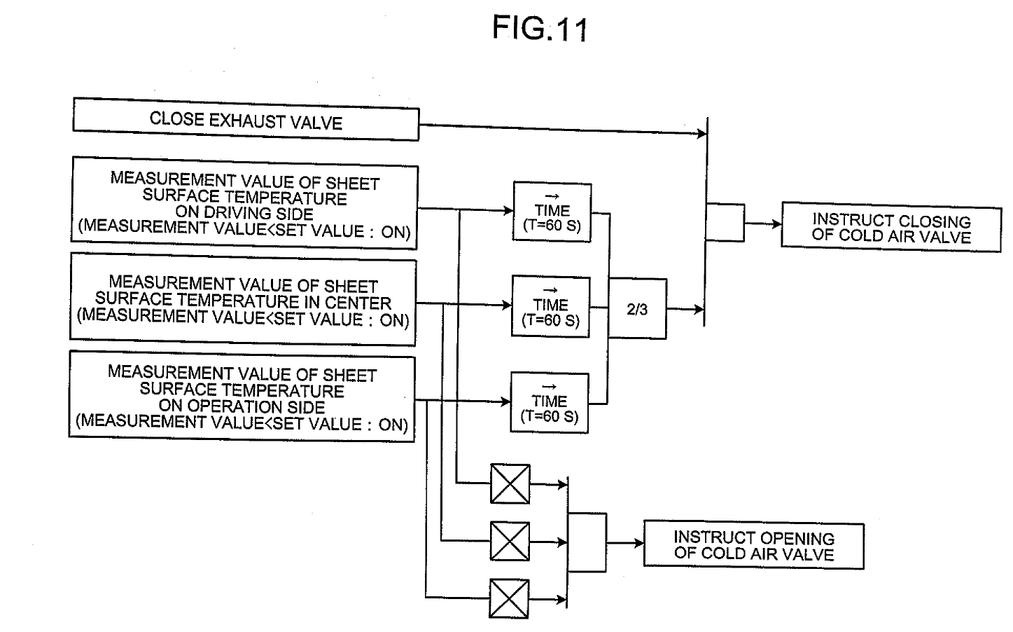

FIG. 8 is a schematic diagram of a water-based-varnish drying apparatus for a printing press according to a second embodiment of the present invention. FIG. 9 is a schematic diagram of a control block in the water-based-varnish drying apparatus for a printing press according to the second embodiment. FIG. 10 is a schematic diagram of output control for an exhaust device in the water-based-varnish drying apparatus for a printing press according to the second embodiment. FIG. 11 is a schematic diagram of output control for a cooling device in the water-based-varnish drying apparatus for a printing press according to the second embodiment.

A duplex offset sheet printing press to which the water-based-varnish drying apparatus for a printing press according to the second embodiment is applied includes, as shown in FIG. 8, a back-side printing unit 111, a back-side coating unit 112, a translink unit 113, and a front-side printing unit 114 arranged in order in a sheet conveyance direction. The duplex offset sheet printing press applies printing to the rear side of the sheet S and, then, applies printing to the front side of the sheet S without reversing the sheet S.

The back-side printing unit 111 applies printing to the rear side (one side) of the sheet S fed from a not-shown feeder unit and, then, passes the sheet S to the back-side coating unit 112 via a transfer cylinder 115. The transfer cylinder 115 rotates in synchronization with the conveyance of the sheet S while being in contact with the rear side of the sheet S.

The back-side coating unit 112 includes a impression cylinder 116 that receives the sheet S from the back-side printing unit 111 and rotates in synchronization with the conveyance of the sheet S while being in contact with the surface of the sheet S and a water-based-varnish applying device 117 that is provided to be opposed to the impression cylinder 116 across the sheet S and applies a water-based-varnish on the rear side of the sheet S. The water-based-varnish applying device 117 mainly includes a varnish pan 117a that stores the water-based-varnish, a varnish fountain roller 117b provided to be immersed in the varnish pan 117a, a varnish form roller 117c provided to be in contact with the varnish fountain roller 117b, and a varnish printing cylinder 117d provided to be in contact with the varnish form roller 117c and the rear side of the sheet S supported by the peripheral surface of the impression cylinder 116 and conveyed. Consequently, the water-based-varnish stored in the varnish pan 117a is properly kneaded by the varnish fountain roller 117b and the varnish form roller 117c and applied on the rear side of the sheet S via the varnish printing cylinder 117d. The sheet S applied with the water-based-varnish by the back-side coating unit 112 is passed to the translink unit 113.

The translink unit 113 includes a plurality of transfer cylinders 118, 119, 120, and 121 that convey the sheet S, which is passed from the back-side coating unit 112, to the front-side printing unit 114. Specifically, the translink unit 113 includes a first transfer cylinder 118 that receives the sheet S from the impression cylinder 116 of the back-side coating unit 112, a second transfer cylinder 119 that is provided further on the downstream side in the sheet conveyance direction than the first transfer cylinder 118 and receives the sheet S from the first transfer cylinder 118, a third transfer cylinder 120 that is provided further on the downstream side in the sheet conveyance direction than the second transfer cylinder 119 and receives the sheet S from the second transfer cylinder 119, and a fourth transfer cylinder 121 that is provided further on the downstream side in the sheet conveyance direction than the third transfer cylinder 120 and receives the sheet S from the third transfer cylinder 120.

The first transfer cylinder 118, the second transfer cylinder 119, the third transfer cylinder 120, and the fourth transfer cylinder 121 rotate in synchronization with the conveyance of the sheet S while being in contact with the rear side of the sheet S, the front side of the sheet S, the rear side of the sheet S, and the front side of the sheet S, respectively, (i.e., while supporting the sheet S on the peripheral surfaces thereof) to convey the sheet S to the front-side printing unit 114. The first transfer cylinder 118 is arranged in a position obliquely above the impression cylinder 116 of the back-side coating unit 112. The first transfer cylinder 118, the second transfer cylinder 119, the third transfer cylinder 120, and the fourth transfer cylinder 121 are arranged in order in a downward direction.

The front-side printing unit 114 mainly includes a impression cylinder 122 that receives the sheet S from the fourth transfer cylinder 121 of the translink unit 113 and rotates in synchronization with the conveyance of the sheet S while being in contact with the rear side of the sheet S, a printing cylinder 123 that has a printing plate 123a wound around thereof, to which an ink and an immersion liquid are supplied, and a blanket cylinder 124 that is in contact with the printing cylinder 123 and the surface of the sheet S supported by the peripheral surfaced of the impression cylinder 122 and conveyed and transfers a pattern on the surface of the printing cylinder 123 onto the surface of the sheet S. Components such as an ink supplying device and an immersion-liquid supplying device are not shown in the figure.

The water-based-varnish drying apparatus according to the present embodiment dries a water-based-varnish on the sheet S conveyed between the back-side coating unit 112 and the front-side printing unit 114 of the duplex offset printing press described above. Specifically, the water-based-varnish drying apparatus mainly includes a heating device (a heating unit) 125 that heats the sheet S, a first temperature sensor (a first measuring unit) 126 that measures a sheet surface temperature of the sheet S heated by the heating device 125, a cooling device (a cooling unit) 127 that is provided further on the downstream side in the sheet conveyance direction than the first temperature sensor 126 and cools the sheet S, a second temperature sensor (a second measuring unit) 128 that measures a sheet surface temperature of the sheet S cooled by the cooling device 127, exhaust devices (exhaust units) 129, 130, and 131 that discharge a hot air in the translink unit 113 to the outside of the printing press, a third temperature sensor (an ambient-temperature measuring unit) 132 that measures an ambient temperature in the translink unit 113, and a control device 133 that controls the heating device 125, the cooling device 127, and the exhaust devices 129, 130, and 131.

The heating device 125 includes IR irradiating devices 134a, 134b, and 134c that irradiate infrared rays (IRs) and hot-air blowing devices 135a and 135b that blow hot airs. The IR irradiating device 134a is provided in a position further on the upstream side in the sheet conveyance direction than an opposed-contact unit of the impression cylinder 116 of the back-side coating unit 112 and the first transfer cylinder 118 of the translink unit 113. The IR irradiating device 134a irradiates an IR on the rear side of the sheet S immediately before being passed from the impression cylinder 116 of the back-side coating unit 112 to the first transfer cylinder 118 of the translink unit 113 and heats the sheet S. This makes it possible to heat the sheet S having the water-based-varnish applied thereon at a relatively early stage in the back-side coating unit 112.

The IR irradiating devices 134b and 134c are provided side by side below the second transfer cylinder 119 of the translink unit 113 along the sheet conveyance path. The IR irradiating devices 134b and 134c irradiate IRs on the rear side of the sheet S supported by the peripheral surface of the second transfer cylinder 119 and conveyed and heat the sheet S. The IR irradiating devices 134a, 134b, and 134c can adjust outputs (heating temperatures) by adjusting supplied power. The hot-air blowing device 135a is provided in a position further on the downstream side in the sheet conveyance direction than an opposed-contact unit of the first transfer cylinder 118 and the second transfer cylinder 119 of the translink unit 113 and further on the upstream side in the sheet conveyance direction than the IR irradiating device 134a. The hot-air blowing device 135a blows a hot air on the rear side of the sheet S supported by the peripheral surface of the second transfer cylinder 119 and conveyed and heats the sheet S. The hot-air blowing device 135b is provided in a position further on the downstream side in the sheet conveyance direction than the IR irradiating device 134b and further on the upstream side in the sheet conveyance direction than the IR irradiating device 134c. Like the hot-air blowing device 135a, the hot-air blowing device 135b blows a hot air on the rear side of the sheet S supported by the peripheral surface of the second transfer cylinder 119 and conveyed and heats the sheet S.

In control of the water-based-varnish drying apparatus according to the present embodiment, as shown in FIG. 9, specifically, the hot-air blowing device 135a mainly includes a hot air generator 136a that generates a hot air and a suction fan 137a that sucks the atmosphere and sends the atmosphere to the hot air generator 136a. It is possible to adjust an output (a heating temperature) of the hot-air blowing device 135a by adjusting a hot air temperature of the hot air generator 136a. Similarly, the hot-air blowing device 135b mainly includes a hot air generator 136b that generates a hot air and a suction fan 137b that sucks the atmosphere and sends the atmosphere to the hot air generator 136b. It is possible to adjust an output (a heating temperature) of the hot-air blowing device 135b by adjusting a hot air temperature of the hot air generator 136b. In FIG. 9, for convenience of illustration, the respective components are shown on the outside of a printing press (M/C).

In this way, the IR irradiating devices 134a, 134b, and 134c and the hot-air blowing devices 135a and 135b are provided on the rear side of the sheet S to efficiently heat the sheet S and completely dry the water-based-varnish applied on the rear side of the sheet S. Since the IR irradiating devices 134a, 134b, and 134c and the hot-air blowing devices 135a and 135b are provided alternately on the sheet conveyance path, it is possible to more efficiently heat the sheet S.

The first temperature sensor 126 is a non-contact temperature sensor. The first temperature sensor 126 is provided in a position further on the downstream side in the sheet conveyance direction than the IR irradiating device 134c and further on the upstream side in the sheet conveyance direction than an opposed-contact unit of the second transfer cylinder 119 and the third transfer cylinder 120. The first temperature sensor 126 always measures a sheet surface temperature of the sheet S supported by the peripheral surface of the second transfer cylinder 119 and conveyed. The first temperature sensor 126 is provided near the center in a printing press width direction of the sheet S, and measures a sheet surface temperature in the center in the printing press width direction of the sheet S.

The cooling device 127 includes cold-air blowing devices 138a and 138b that blow cold airs to the sheet S. The cold-air blowing device 138a is provided in a position further on the downstream side in the sheet conveyance direction than the opposed-contact unit of the second transfer cylinder 119 and the third transfer cylinder 120 of the translink unit 113 and further on the upstream side in the sheet conveyance direction than an opposed-contact unit of the third transfer cylinder 120 and the fourth transfer cylinder 121 (i.e., above the third transfer cylinder 120). The cold-air blowing device 138a blows a cold air on the front side of the sheet S. The cold-air blowing device 138b is provided further on the downstream side in the sheet conveyance direction than the opposed-contact unit of the third transfer cylinder 120 and the fourth transfer cylinder 121 of the translink unit 113 and further on the upstream side in the sheet conveyance direction than an opposed-contact unit of the fourth transfer cylinder 121 and the impression cylinder 122 of the front-side printing unit 114 (a position close to the opposed-contact unit of the third transfer cylinder 120 and the fourth transfer cylinder 121 of the translink unit 113). The cold-air blowing device 138b blows a cold air on the rear side of the sheet S. This makes it possible to efficiently cool the sheet S.

Specifically, the cold-air blowing device 138a mainly includes a cooler (a cold air generator) 139a that generates a cold air, a blowing fan 140a that delivers the cold air generated by the cooler 139a, and a cold-air regulation valve 141a that can adjust a flow rate of the cold air delivered. It is possible to adjust an output (a cooling temperature) of the cold-air blowing device 138a by opening and closing the cold-air regulation valve 141a. Similarly, the cold-air blowing device 138b mainly includes a cooler (a cold air generator) 139b that generates a cold air, a blowing fan 140b that delivers the cold air generated by the cooler 139b, and a cold-air regulation valve 141b that can adjust a flow rate of the cold air delivered. It is possible to adjust an output (a cooling temperature) of the cold-air blowing device 138b by opening and closing the cold-air regulation valve 141b.

The second temperature sensor 128 is a non-contact temperature sensor. The second temperature sensor 128 is provided in a position further on the downstream side in the sheet conveyance direction than the cold-air blowing device 138 and further on the upstream side in the sheet conveyance direction than the opposed-contact unit of the fourth transfer cylinder 121 and the impression cylinder 122 of the front-side printing unit 114 (a position close to the cold-air blowing device 138b). The second temperature sensor 128 always measures a sheet surface temperature of the sheet S supported by the peripheral surface of the fourth transfer cylinder 121 and conveyed. The second temperature sensor 128 is provided near the center in the printing press width direction of the sheet S and measures a sheet surface temperature in the center in the printing press width direction of the sheet S.

The exhaust devices 129, 130, and 131 are set above the back-side coating unit 112, above the translink unit 113, and below the translink unit 113, respectively, and discharge the air (the hot air) in the printing press to the outside.

According to the present embodiment, the exhaust device 130 mainly includes an exhaust fan 142a that discharges the air in the printing press to the out side from an upper part of the translink unit 113 and an exhaust-air regulation valve 143a that can adjust a quantity of the air discharged by the exhaust fan 142a. It is possible to adjust an output (an exhaust quantity) of the exhaust device 130 by opening and closing the exhaust-air regulation valve 143a. Similarly, the exhaust device 131 mainly includes an exhaust fan 142b that discharges the air in the printing press to the outside from a lower part of the translink unit 113 and an exhaust-air regulation valve 143b that can adjust a quantity of the air discharged by the exhaust fan 142b. It is possible to adjust an output (an exhaust quantity) of the exhaust device 131 by opening and closing the exhaust-air regulation valve 143b. According to the present embodiment, an exhaust-air regulation valve is not provided in the exhaust device 129. The exhaust device 129 always discharges a predetermined quantity of the air from an upper part of the back-side coating unit 112.

Referring back to FIG. 1, the third temperature sensor 132 is provided, for example, in a position near the second transfer cylinder 119 in the translink unit 113. The third temperature sensor 132 always measures an ambient temperature in the translink unit 113. The third temperature sensor 132 does not have to be a non-contact temperature sensor. However, since the ambient temperature in the translink unit 113 tends to be affected by the second transfer cylinder 119 in which a surface temperature rise is relatively large, it is preferable to measure a surface temperature of the second transfer cylinder 119. In this case, it is advisable to use a non-contact sensor as the third temperature sensor 132.

The control device 133 is, for example, a computer. The control device 34 has functions corresponding to a heating control unit (a heating control unit) 133a that controls an output of the heating device 125 based on measurement information from the first temperature sensor 126, a cooling control unit (a cooling control unit) 133b that controls an output of the cooling device 127 based on measurement information from the second temperature sensor 128, an exhaust control unit (an exhaust control unit) 133c that controls an output of the exhaust devices 129, 130, and 131 based on measurement information from the first temperature sensor 126, and an operation control unit 133d that controls operation of the printing press based on measurement information from the third temperature sensor 132.

Measurement information (i.e., information on a sheet surface temperature of the sheet S heated by the IR irradiating devices 134a, 134b, and 134c and the hot-air blowing devices 135a and 135b) from the first temperature sensor 126. The heating control unit 133a increases or decreases outputs of the IR irradiating devices 134a, 134b, and 134c and the hot-air blowing devices 135a and 135b to set the sheet surface temperature of the sheet S obtained from the first temperature sensor 126 to a first predetermined temperature (e.g., temperature necessary for a water-based-varnish to dry) set in advance.

Measurement information (i.e., information on a sheet surface temperature of the sheet S cooled by the cold-air blowing devices 138a and 138b) from the second temperature sensor 128 is inputted to the cooling control unit 133b. The cooling control unit 133b increases or decreases outputs of the cold-air blowing devices 138a and 138b to set the sheet surface temperature of the sheet S obtained from the second temperature sensor 128 to a second predetermined temperature (temperature lower than the first predetermined temperature. Specifically, temperature necessary for pattern registration in the front-side printing unit 114) set in advance.

Specifically, at the time of normal operation, the cooling control unit 133b basically sets the cold-air regulation valves 141a and 141b of the cold-air blowing devices 138a and 138b in an open state to always blow a cold air to the sheet S. However, when the sheet surface temperature of the sheet S obtained from the second temperature sensor 128 falls to be lower than the second predetermined temperature, the cooling control unit 133b brings the cold-air regulation valve 141a and 141b of the cold-air blowing devices 138a and 138b into a closed state to stop outputs of the cold-air blowing devices 138a and 138b. When the sheet surface temperature of the sheet S obtained from the second temperature sensor 128 rises to be higher than the second predetermined temperature, the cooling control unit 133b brings the cold-air regulation valves 141a and 141b of the cold-air blowing devices 138a and 138b into the open state to blow the cold air to the sheet S again. This makes it possible to hold down outputs of the cold-air blowing devices 138a and 138b to necessary minimum outputs.

Measurement information (i.e., information on a sheet surface temperature of the sheet S heated by the IR irradiating devices 134a, 134b, and 134c and the hot-air blowing devices 135a and 135b) from the first temperature sensor 126 is inputted to the exhaust control unit 133c. At the time of normal operation, the exhaust control unit 133c sets the exhaust-air regulation valves 143a and 143b of the exhaust devices 130 and 131 in the closed state not to perform exhaust. However, when the sheet surface temperature of the sheet S obtained from the first temperature sensor 126 rises to be higher than the first predetermined temperature and this state continues for a predetermined time (e.g., 60 seconds), the exhaust control unit 133c brings the exhaust-air regulation valves 143a and 143b of the exhaust devices 130 and 131 into the open state to perform exhaust. When the sheet surface temperature of the sheet S obtained from the first temperature sensor 126 falls to be lower than the first predetermined temperature, the exhaust control unit 133c brings the exhaust-air regulation valves 143a and 143b of the exhaust devices 130 and 131 into the closed state to stop exhaust again. This makes it possible to hold down outputs of the exhaust devices 130 and 131 to necessary minimum outputs. When the sheet surface temperature of the sheet S continues to be higher than the first predetermined temperature for a long time regardless of the fact that the exhaust-air regulation valves 143a and 143b are brought into the open state, it is likely that the ambient temperature in the translink unit 113 rises to damage the printing press. Thus, in order to prevent this situation, when the ambient temperature in the translink unit 113 is measured and the printing press is in an abnormal temperature state, operation of the printing press is stopped.

Measurement information (i.e., information on the ambient temperature in the translink unit 113) from the third temperature sensor 132 is inputted to the operation control unit 133d. When the ambient temperature in the translink unit 113 rises to be equal to or higher than a third predetermined temperature (e.g., 100° C.) set in advance, the operation control unit 133d judges that the inside of the printing press is in the abnormal temperature state and stops operation of the printing press. When the inside of the printing press is in the abnormal temperature state, it is likely that the pawls of the printing cylinder and the conveyance cylinder gripping the sheet S loosen to drop the sheet S during conveyance of the sheet S. The abnormal temperature state damages the printing press. Thus, when the inside of the printing press is in the abnormal temperature state in this way, it is preferable to stop operation of the printing press.

The water-based-varnish drying apparatus for a duplex printing press according the second embodiment is constituted as described above. Thus, outputs of the IR irradiating devices 134a, 134b, and 134c and the hot-air blowing devices 135a and 135b are automatically controlled to set the sheet surface temperature of the sheet S to temperature most suitable for the water-based-varnish to dry (the first predetermined temperature). This makes it possible to completely dry the water-based-varnish. Therefore, the water-based-varnish does not peel off at the time of printing in the back-side printing unit. It is possible to improve a print quality.

Outputs of the cold-air blowing devices 138a and 138b are automatically controlled to set the sheet surface temperature of the sheet S to temperature most suitable for pattern registration in the front-side printing unit 114 (the second predetermined temperature). This makes it possible prevent occurrence of wrong pattern registration in the front-side printing unit 114 and improve a print quality.

The second embodiment of the present invention has been explained. However, the present invention is not limited to the embodiments described above. It is possible to modify the embodiments variously and carry out the present invention without departing from the spirit of the present invention.

For example, the first temperature sensors 126 may be provided in three places on the driving side (one end side), in the center, and on the operation side (the other end side) in the printing press width direction of the sheet S to measure sheet surface temperatures in the three places. In this case, as shown in FIG. 10, when measurement values in at least the two places of measurement values in the three places measured by the first temperature sensors 126 are higher than a set value (i.e., the first predetermined temperature) continuously for one minute, the exhaust-air regulation valves 143a and 143b of the exhaust devices 130 and 131 are brought into the open state to perform exhaust. When all the measurement values in the three places measured by the first temperature sensors 126 are equal to or lower than the set value (the first predetermined temperature), the exhaust-air regulation valves 143a and 143b of the exhaust devices 130 and 131 are brought into the closed state to stop exhaust.

The second temperature sensors 128 may be provided in three places on the driving side (one end side), in the center, and on the operation side (the other end side) in the printing press width direction of the sheet S to measure sheet surface temperatures in the three places. In this case, as shown in FIG. 11, in the closed state of the exhaust-air regulation valves 143a and 143b of the exhaust devices 130 and 131, when measurement values in at least the two places of measurement values in the three places measured by the second temperature sensors 128 are lower than a set value (i.e., the second predetermined value) continuously for one minute, the cold-air regulation valves 141a and 141b of the cold-air blowing devices 138a and 138b are brought into the closed state to stop cold air supply. When all the measurement values in the three places measured by the second temperature sensors 128 are equal to or higher than the set value (the first predetermined temperature), the cold-air regulation valves 141a and 141b of the cold-air blowing devices 138a and 138b are brought into the open state to supply a cold air.

In the explanation of the present embodiment, the water-based-varnish drying apparatus is used for the duplex printing press that applies printing to both the sides of the sheet S without reversing the sheet S. However, the water-based-varnish drying apparatus may be used for a duplex printing press that includes a reversal cylinder for reversing the paper S and applies printing to both the sides of the sheet S by reversing the sheet S. According to the present embodiment, the most suitable arrangements of the IR irradiating devices 134a, 134b, and 134c, the hot-air blowing devices 135a and 135b, the cold-air blowing devices 138a and 138b, and the exhaust devices 130 and 131a re explained. However, for example, the number of arrangements of the respective devices may be further increased.

A range (a predetermined temperature width) may be set for the first predetermined temperature to control the heating unit to set a sheet surface temperature of a sheet within this range (feedback control).

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. An apparatus for drying a water-based varnish coated on a surface of an ink that is transferred onto one side of a sheet in a printing press, the apparatus comprising:
a heating unit that heats the sheet;
a first measuring unit that measures or estimates a first temperature of surface of the sheet before the sheet is conveyed to the heating unit; and
a heating control unit that controls an output of the heating unit, in such a manner that the first temperature output from the first measuring unit becomes equal to or higher than a first predetermined temperature that is necessary for drying the varnish.

2. The apparatus according to claim 1, wherein
the heating unit includes
an infrared irradiating unit that irradiates an infrared on one side of the sheet; and
a hot-air blowing unit that blows a hot air on the one side of the sheet, and
the heating control unit controls an output of the infrared irradiating unit based on the first temperature.

3. The apparatus according to claim 1, wherein
the first measuring unit measures or estimates the first temperature of the surface of the sheet at a center and both ends of the sheet in a width direction orthogonal to a sheet conveyance direction, and
the heating control unit increases or decreases the output of the heating unit when the first temperature of at least one place from among the center and both ends of the sheet is deviated from the first predetermined temperature.

4. The apparatus according to claim 1, wherein
the heating control unit increases or decreases the output of the heating unit when a state in which the first temperature is deviated from the first predetermined temperature is continued for a predetermined time.

5. The apparatus according to claim 1, wherein
when the first temperature is decreased to a first lower-limit temperature below the first predetermined temperature after the output of the heating unit is decreased due to an increase of the first temperature higher than the first predetermined temperature, the heating control unit maintains the output of the heating unit.

6. The apparatus according to claim 1, wherein
when the first temperature is increased to a first upper-limit temperature higher than the first predetermined temperature after the output of the heating unit is increased due to a decrease of the first temperature below the first predetermined temperature, the heating control unit maintains the output of the heating unit.

7. The apparatus according to claim 1, further comprising:
a cooling unit that cools a sheet located on a downstream side of the heating unit in the sheet conveyance direction;
a second measuring unit that measures or estimates a second temperature of the surface of the sheet after the sheet is conveyed from the cooling unit; and
a cooling control unit that controls an output of the cooling unit, in such a manner that the second temperature output from the second measuring unit becomes equal to or lower than a second predetermined temperature that is necessary for discharging the sheet.

8. The apparatus according to claim 7, wherein
the cooling unit includes a cold-air blowing unit that blows a cold air on the one side of the sheet, and
the cooling control unit increases or decreases an air volume or an air speed of the cold-air blowing unit based on the second temperature.

9. The apparatus according to claim 1, further comprising:
an exhaust unit that exhausts an air in the printing press to outside;
a third measuring unit that measures or estimates a third temperature of an internal ambient near the heating unit; and
an exhaust control unit that controls an output of the exhaust unit, in such a manner that the third temperature output from the third measuring unit becomes equal to or lower than a third predetermined temperature that is necessary for a normal operation of the printing press.

10. The apparatus according to claim 9, wherein the exhaust control unit increases or decreases an amount of exhaust by the exhaust unit based on the third temperature.

11. The apparatus according to claim 9, further comprising:
a safety control unit that issues an alarm or stops the printing press when the third temperature is increased to a fourth predetermined temperature at which an abnormal driving of the printing press is anticipated.

12. The apparatus according to claim 1, wherein
the printing press is a duplex printing press that performs an ink transfer, a varnish coating, and a varnish drying on both sides of the sheet including a front side and a rear side, and
the apparatus is for drying the varnish coated on the front side of the sheet.

13. A printing press comprising:
a coating device that applies a water-based varnish on a surface of a sheet onto which an ink is transferred; and
a drying device that dries the varnish coated on the surface of the sheet, the drying device including
a heating unit that heats the sheet;
a measuring unit that measures or estimates a temperature of surface of the sheet before the sheet is conveyed to the heating unit; and
a heating control unit that controls an output of the heating unit, in such a manner that the temperature output from the measuring unit becomes equal to or higher than a predetermined temperature that is necessary for drying the varnish.

14. An apparatus for drying a water-based varnish coated on a surface of an ink that is transferred onto one side of a sheet in a printing press, the apparatus comprising:
a heating unit that heats the sheet;
a first measuring unit that measures or estimates a first temperature of surface of the sheet heated by the heating unit; and
a heating control unit that controls an output of the heating unit, in such a manner that the first temperature output from the first measuring unit becomes equal to or higher than a first predetermined temperature that is necessary for drying the varnish.

15. The apparatus according to claim 14, wherein
the heating unit includes
an infrared irradiating unit that irradiates an infrared on one side of the sheet; and
a hot-air blowing unit that blows a hot air on the one side of the sheet, and
a plurality of infrared irradiating units and a plurality of hot-air blowing units are alternately provided in a sheet conveyance direction.

16. The apparatus according to claim 14, further comprising:
a cooling unit that cools a sheet located on a downstream side of the heating unit in the sheet conveyance direction;
a second measuring unit that measures or estimates a second temperature of the surface of the sheet after the sheet is conveyed from the cooling unit; and
a cooling control unit that controls an output of the cooling unit, in such a manner that the second temperature output from the second measuring unit becomes a second predetermined temperature that is necessary for a pattern registration.
